(19) United States
(12) Patent Application Publication
(10) Pub. No.: US 2007/0015948 A1
(43) Pub. Date: Jan. 18, 2007

(54) Stabilization of waste material

(75) Inventors: Bradley Cadieux, Airdrie (CA); Aaron Trites, Airdrie (CA)

Correspondence Address: LERNER, DAVID, LITTENBERG,;KRUMHOLZ & MENTLIK, 600 SOUTH AVENUE WEST, WESTFIELD, NJ, 07090, US

(73) Assignee: Newpark Canada Inc., Calgary (CA)

(21) Appl. No.: 11/484,424

(22) Filed: Jul. 11, 2006

(30) Foreign Application Priority Data
Jul. 15, 2005 (CA) 2512289

(51) Int. Cl. B09B 3/00

(52) U.S. Cl. 588/252

(57) ABSTRACT

There is described a method of treating a waste having both liquid and solid fractions, the method consisting of adding to the waste a mineral absorbent in an amount from about 1.5 to 10 weight percent of the waste.

### FIELD OF THE INVENTION

The present invention relates to the treatment of fluid acting waste for transport and disposal and more specifically to the stabilization of slurries and sludges.

### BACKGROUND OF THE INVENTION

High solids content waste streams often contain enough water or other fluid to behave like a sludge or slurry. In this state, the waste is difficult to store, transport and dispose of. By way of example, oil and gas well drilling wastes can have a high proportion of solids in the form of cuttings generated as the bit penetrates the ground. The cuttings are returned to the surface by the flow of drilling fluid, usually referred to as the drilling mud, which is a viscous multi-phase fluid pumped down the well through the drill pipe. The mud exits through the bit and then returns to the surface in the annulus between the drill pipe and the wall of the bore being drilled, carrying the cuttings with it. When drilling is complete, both the mud and the cuttings need to be disposed of, and are together known as drilling waste. To facilitate economic and environmentally safe disposals, it is usually preferable to separate the mud (mostly liquids) and the cuttings (mostly solids) prior to disposal.

Through variations in local geology and the method of drilling, the cuttings from a single well can vary in size from coarse chips to very fine clay sized particles. When the particle size of the cuttings becomes very fine, there is less distinction between the mud and cuttings that are in suspension. Often the very fine suspended cuttings will not readily settle out or separate from the mud, which may reduce the usefulness of the mud for drilling purposes, and complicate the disposal process. There are several commonly used methods to separate drill cuttings from drilling mud. Often several of these methods are used concurrently during the drilling of the well.

The first common method of separating the cuttings from drilling mud is a vibrating shaker box, which has screens of various sizes to separate the coarse cuttings from the flowing mud. The mud gets reused and the cuttings are collected for disposal.

A second method to separate cuttings from drilling mud is through the use of settling tanks or a settling pond, called a sump. This method allows fine cuttings that went through the shaker screens to slowly settle to the bottom. The mud is removed from the top of the tank or sump and reused. A variation of the settling method is called flocculation. Through chemical changes to the mud, very fine cuttings particles cling together to make larger particles, which settle faster.

A third method of separating cuttings from drilling mud is through the use of centrifuge. Usually centrifuging is combined with chemical flocculation of the mud, and will rapidly strip most of the very fine cuttings from the mud. The mud is reused and the very fine cuttings are usually left in the form of a thick heavy sludge.

After the drill cuttings (mostly solids) are separated from the drilling mud (mostly liquids) by the methods described above, the drill cuttings will normally be defined as a solid based on EPA method 9095A, also known as the paint filter test. However, the common methods of separating solid cuttings from drilling mud described above are not 100% effective. There is always a small amount of fluid in the interstitial pore spaces of the drill cuttings that is not economically viable to remove. It is during the process of storing or transporting these cuttings, that this small amount of fluid becomes problematic.

In the case of coarse drill cuttings, liquids can be forced out of the interstitial pore spaces as the cuttings settle through time, or by the shaking and vibration during long distance transport. The finer drill cuttings in the form of a thick sludge or slurry will often change to flow like a liquid if transported, spilled, or agitated in any way, much like quick sand. This makes the storage, handling and transportation of this drilling waste to approved facilities, difficult, dangerous and expensive. Drilling waste is just one example of waste streams that, although technically a solid, can behave in this manner. Such streams will sometimes be referred to as fluidic wastes, meaning solid wastes that under certain conditions will behave like a fluid

The solid drill cuttings must therefore be stabilized by solidification prior to safe storage, transport and disposal.

Sludge stabilization and solidification techniques are known in the art and reference is made in this regard to U.S. Pat. Nos. 4,113,504, 4,913,585, 5,916,122 and 6,322,489. Some of these technologies however are not suitable for waste streams intended to be handled by conventional loaders and trucks, for example because they involve actual cementitious solidification to prevent leaching of heavy metals (U.S. Pat. No. 4,113,504). U.S. Pat. No. 6,322,489 teaches a method of encapsulation that will render the waste sufficiently safe for disposal in wetlands. Encapsulation at this level of safety is not realistically or economically sustainable on an industry wide basis.

More practically, drilling wastes are stabilized with wood fiber waste which itself is a waste stream from the pulp and paper and lumber industries. There is now however sufficient demand for wood waste that the industry is charging for the product. The use of wood waste also requires specialized trucks to transport treated waste, all of which makes the use of wood waste increasingly expensive.

There are other disadvantages to the use of wood waste as a stabilization agent. Its moisture content fluctuates with the seasons and/or its exposure to the elements, affecting its absorption rate. Particle size, density and consistency are also subject to considerable and unpredictable fluctuation.

Moreover, it is not a particularly good absorbent. It is common to add 30 to 50% wood fibre (by weight) to the drilling waste for adequate stabilization. Use of these amounts can be effective, but the result is an additional 30 to 50% of added waste tonnage for transport. In addition to adding tonnage, the wood waste can reduce the specific gravity of the stabilized waste to as little as 0.7 to 1.2, which substantially reduces the efficiency of transporting the material by truck. The trucks become full long before reaching their maximum weight capacity. To compensate for the light loads, truck operators will charge by the trip instead of by tonnage. Therefore costs will be higher in view of the greater number of loads required, operator hours, fuel consumed and tippage at a landfill.

### SUMMARY OF THE INVENTION

The applicant has found that the use of a mineral absorbent and/or a mineral adsorbent, or blends thereof, when mixed with drilling wastes, produces a stable and easy to handle mixture that can be loaded and handled using conventional dirt moving equipment such as shovels, loaders and dump trucks. These additives also provide structure to the mixed waste, which can therefore be advantageously stored in a stable pile while awaiting transport for disposal. Unmixed slurries and sludges simply slough and spread if piled.

To facilitate the following description of the invention, the word “absorbent” is meant to include one or both of an actual absorbent, which is penetrated by the substance being absorbed, or an adsorbent, which retains that substance on its surface, unless the context indicates to the contrary. The purpose of the absorbent/adsorbent is essentially the same and that is to take up the liquid fraction so that the remaining waste behaves more like a stable solid.

The use of mineral absorbents produces a consistently dry product. The applicants have found that the required amount to stabilize sludgy drilling waste is from about 1.5% to about 10% and advantageously 2% to 3% by weight of the drilling waste. This is subject to factors such as the nature of the waste stream, the equipment used to drill the well, particle size, the solids control equipment used on the well, the mud system used in the well and other variables normally associated with the drilling of a bore hole. It is expected that in some applications, the amount of stabilizer required may be more or less than this range, but test results to date indicate that about 2% to 10% provides commercial utility.

The use of so little absorbent means that the specific gravity of the waste is reduced only slightly so that trucking becomes far more efficient. Based on studies performed by the applicant using historical data, wells that normally produce 700 tonnes of drilling waste after treatment with wood fiber produce 400 or fewer tonnes of drilling waste using the applicant's mineral adsorbents/absorbents or blends thereof. This represents a significant 300 fewer tonnes to transport and dispose of. Disposal costs at a landfill (tipping) are typically $25.00 to $40.00 per tonne. Haulage per tonne is considerably more expensive than the tipping. Haulage per tonne can become exorbitant when extremely long hauling distances are involved. For example, in environmentally sensitive areas such as the Arctic, there are typically no close disposal facilities. Therefore, the economic benefits of this invention can be considerable compared to the current industry standard of wood fibre.

Accordingly, it is an object of the present invention to provide a method of stabilizing drilling waste streams that obviates and mitigates the disadvantages of the prior art.

According to the present invention, there is provided a method of treating waste having both liquid and solid fractions, the method comprising adding to said waste a mineral absorbent in an amount from about 1.5 to 10 weight percent of said waste.

According to another aspect of the present invention, there is provided a method of stabilizing a fluidic waste having both liquid and solid fractions therein, the method comprising mixing said fluidic waste with a mineral absorbent and/or adsorbent in an amount from about 1.5 to 10 weight percent of said fluidic waste.

According to yet another aspect of the present invention, there is also provided a method of drying drilling waste having both liquid and solid fractions that is in the form of a sludge or slurry, the method comprising adding a mineral absorbent to said waste and blending said waste and said absorbent together for a predetermined amount of time until said waste behaves like a solid.

According to yet a further aspect of the present invention, there is also provided a method of solidifying a fluid acting waste which includes a major solids fraction and a minor fluids fraction, the method comprising blending said waste with a mineral additive that absorbs and/or adsorbs some or all of said fluid fraction, said mineral additive being present in an amount from about 1.5 to 10 weight percent of said waste.

According to yet a further aspect of the present invention, there is also provided a method of drying and solidifying a waste in the form of a sludge or slurry, the method comprising mixing said sludge or slurry with at least one mineral additive adapted to adsorb and/or adsorb some or all of liquid in said sludge or slurry, said mixing continuing until said sludge or slurry and said mineral additive are thoroughly blended whereby said sludge or slurry becomes stackable without sloughing, said mineral additive being added to said sludge or slurry in an amount from about 1.5 to 10 weight percent of said sludge or slurry.

According to yet another aspect of the present invention, there is also provided a mineral additive for the stabilization of fluid acting waste which have both a solid and liquid fraction, said additive comprising a blend of vermiculite and one or both of perlite and zeolite.

According to yet another aspect of the present invention, there is provided a method of treating waste comprising both liquid and solid fractions for disposal by adding to said waste a mineral absorbent in an amount of from about 2 to 10 weight percent of said drilling waste.

### DETAILED DESCRIPTION OF THE PREFERRED EMBODIMENTS

The following description is provided with reference to the stabilization of drilling waste from the drilling of oil and gas wells. This use is intended however to be exemplary only, and the present invention will be equally useful with respect to other wastes comprising both liquid and solid fractions that can behave like a fluid. As used herein, stabilization is intended to include one or both of drying and solidification, with solidification meaning that the treated waste acts or has the characteristics of a substantially dry particulate.

In accordance with a preferred aspect of the present invention, drilling waste is stabilized by the addition of a mineral absorbent and/or adsorbent. The mineral absorbent is advantageously expanded vermiculite having a particle size in the range of a 5 mesh sieve to a 200 mesh sieve and a specific gravity of 0.1 g/cm³ to 0.2 g/cm³. Vermiculite is available from suppliers such as Grace Construction Products for commercial/industrial use. Vermiculite is also widely available at a retail level at numerous hardware, and home and garden establishments.

Depending upon the desired characteristics of the mixed waste, the vermiculite can be blended with other mineral components including perlite and zeolite. The perlite typically has a particle size in the range of a five mesh sieve to a 200 mesh sieve and a density of 0.10 g/cm³ to 0.30 g/cm³. The zeolite particles typically range in size from a 10 mesh sieve to a 200 mesh sieve and have a density of 0.80 g/cm³ to 1.20 g/cm³.

The ratio of vermiculite to these additives is not critical and will vary depending upon the desired characteristics of the mixed drilling waste. In a typical application however, the respective weight ratios of vermiculite, perlite fines, and zeolite would be 5:3:2. That is, for every 10 parts by weight of the mineral blend, 5 parts by weight would be vermiculite, 3 parts by weight would be perlite fines, and 2 parts by weight would be zeolite. This can also be expressed as a volume ratio, or using other proportions.

The exact ratio of vermiculite to perlite and/or zeolite will vary with empirical observation and experience in any particular area. Drilling equipment, the mud system, solids control equipment, local geology, and weather conditions are common variables that would affect the final blend. Nevertheless, based on testing to date, the ratios described above have proven effective over a broad range of variables.

Each additive to the blend has various advantages and disadvantages that can be adjusted to suit changing needs. For example, both zeolite and perlite are good adsorbents. Although zeolite is heavier and more expensive than fine perlite, it is most effective to stabilize sludgy drilling waste, and make it stackable. If the drilling waste is less sludgy, a higher percentage of perlite could be used, which has the advantage of being less expensive, and lighter than zeolite.

The vermiculite and other principal additives described above can themselves be blended with other optional additives including but not limited to sand, cement, lime, coal dust and granular activated charcoal to obtain complementary characteristics or reactions. For example, sand can be used for traction if the vermiculite mixture is used as an absorbent where slippery floors are a concern. The addition of lime to the vermiculite mixture can be used to change the SAR (sodium adsorbsion ratio) of the drill cuttings as a form of waste treatment in some situations.

The present stabilizing absorbent product is pre-blended, bagged and stored prior to use. It can then be transported by truck to the well site and off loaded using existing equipment. In one application contemplated by the applicant, the stabilizing absorbent is transported in 54 cubic foot totes and is then simply dumped onto the drilling waste using for example an on site loader of one is available. The loader can mix the drilling waste with the stabilizing absorbent until a uniform mixture is achieved.

During mixing process, any interstitial fluid in the drilling waste is absorbed and/or adsorbed by the stabilizer. The size of the drill cuttings in the drilling waste can be reduced by the action of the mixing and the abrasive properties of the stabilizing blend. The reduced size of the drill cuttings increases the overall surface area of the stabilized drilling waste particles relative to its volume, which improves the absorption of fluids. Better blending could be achieved using a pug mill or paddle mixer, but use of the on-site loader is effective and obviously more economic because its already on the site and has its own operator. Once the blended drilling waste is no longer a sludge or slurry, it can be piled without sloughing while awaiting transport. The mixed waste will be sufficiently dry that ordinary dump trucks can be used for transportation.

### EXAMPLE 1

A series of eight similar wells were drilled in North Eastern British Columbia, Canada south of Ft. St. John by an oil and gas operator. All eight wells were drilled with an oil based mud system and the drilling waste generated was tested and then stabilized on the fly with either conventional wood fiber or the mineral absorbent of the present invention, using the loader to mix the stabilizer with the waste. The waste was then contained and batch hauled to a Class 2 landfill for disposal.

The first six wells had the following amounts of waste stabilized with wood fibre dumped at the Class 2 landfill: 820.72, 652.05, 610.25, 936.91, 582.75, 1109.04 metric tonnes respectively, for an average of 785.28 metric tonnes per well. It was not documented how much wood fiber was utilized for stabilization.

The drilling waste from two wells was handled in the same manner, however, the mineral absorbent of the present invention were used instead of wood fiber for stabilization. This commenced on Jul. 28, 2004 and finished on Sep. 23, 2004. A total of 349.54 and 441.20 metric tonnes were hauled. Mineral absorbent use was 7600 Kg's (2.22% wt./wt.) and 8745 Kg's (2.02% wt./wt.) respectively. This was an average of 395.37 metric tonnes per well hauled to the Class 2 landfill.

All weights were scaled at the Class 2 landfill.

### EXAMPLE 2

A well was drilled by an oil and gas operator near the town of Rocky Mountain House, Alberta, Canada in township 042, range 12, west of the 5^{th} meridian. The invert section of the hole began on Apr. 18, 2005 and finished drilling on May 31, 2005. The length of the invert section was 2610 meters with a bit size of 222 mm.

The solid drilling waste from this operation was stored in large horizontal storage tanks on location. After drilling there were five tanks that held a measured 340 m³ of solid drilling waste.

Applicant's personal arrived on site May 27, 2005 to begin stabilization of the waste with the mineral absorbent of the present invention. A Hitachi excavator was used to perform the mixing and any free fluids that may have been encountered were removed with a vacuum unit to ensure regulatory compliance.

A total of 559.82 metric tonnes of material (both solids drilling waste plus the mineral absorbent used) was removed from the tanks and deposited into a Class 2 landfill for disposal. This weight was verified from the Class 2 landfill facility as each dump truck was weighed in and weighed out.

A total of 10,800 Kg of mineral absorbent in accordance with the present invention was used during the stabilization. This equates to 549,020 Kg of waste with the addition of 1.97% wt./wt. of mineral absorbent.

The above-described embodiments of the present invention are meant to be illustrative of preferred embodiments and are not intended to limit the scope of the present invention. Various modifications, which would be readily apparent to one skilled in the art, are intended to be within the scope of the present invention. The only limitations to the scope of the present invention are set forth in the following claims appended hereto.

The embodiments of the invention in which an exclusive property or privilege is claimed are defined as follows:

1. A method of treating waste having both liquid and solid fractions, the method comprising adding to said waste a mineral absorbent in an amount from about 1.5 to 10 weight percent of said waste.

2. The method of any one of claim 1 wherein said mineral is added in an amount from 2 to 3 weight percent of said waste.

3. The method of claim 2 wherein said mineral is vermiculite.

4. The method of claim 2 wherein said mineral is selected from the group consisting of vermiculite, perlite and zeolite and combinations thereof.

5. The method of claim 3 wherein said vermiculite is expanded vermiculite.

6. The method of claim 2 wherein said mineral comprises a blend of vermiculite, perlite and zeolite.

7. The method of claim 7 wherein the ratio of vermiculite to perlite to zeolite is 5:3:2 parts by weight.

8. The method of claim 7 wherein said vermiculite has a particle size in the range of 5 to 200 mesh sieve.

9. The method of claim 8 wherein said vermiculite has a specific gravity in the range of from about 0.1 g/cm³ to 0.2 g/cm³.

10. The method of claim 7 wherein said perlite has a particle size in the range from 5 to 200 mesh sieve.

11. The method of claim 10 wherein said perlite has a specific gravity in the range of from about 0.10 g/cm³ to 0.30 g/cm³.

12. The method of claim 7 wherein said zeolite has a particle size in the range of 10 to 200 mesh sieve.

13. The method of claim 12 wherein said zeolite has a specific gravity in the range of from about 0.8 g/cm³ to 1.2 g/cm³.

14. The method of claim 7 wherein said ratio of vermiculite to perlite to zeolite is adjusted empirically having regard to variables that affect the nature and characteristics of said waste.

15. The method of claim 1 wherein said mineral is blended with additives selected from the group consisting of sand, cement, lime, coal dust and granular activated charcoal and combinations thereof.

16. The method of claim 1 wherein said mineral and said waste are mixed together using one or more of a front end loader, a pug mill or a paddle mixer.

17. A mineral additive for the stabilization of fluid acting waste having both a solid and liquid fraction, said additive comprising a blend of vermiculite and one or both of perlite and zeolite.

18. The mineral additive of claim 24 which is added to said waste in an amount from about 1.5 to 10 weight percent of said waste.

19. The mineral additive of claim 18 wherein said vermiculite has a particle size in the range of 5 to 200 mesh sieve and a specific gravity in the range of from about 0.1 g/cm³ to 0.2 g/cm³.

20. The mineral additive of claim 18 wherein said perlite has a particle size in the range of 5 to 200 mesh sieve and a specific gravity in the range of from about 0.10 g/cm³ to 0.30 g/cm³.

21. The mineral additive of claim 18 wherein said zeolite has a particle size in the range of from 10 to 200 mesh sieve and a specific gravity in the range of from about 0.8 g/cm³ to 1.2 g/cm³.

22. The mineral additive of claim 18 wherein the ratio of vermiculite to perlite to zeolite is 5:3:2.

23. The mineral additive of claim 18 wherein said mineral additive additionally includes additives selected from the group consisting of sand, cement, lime, coal dust and granular activated charcoal and combinations thereof.

24. A method of drying drilling waste having both liquid and solid fractions that is in the form of a sludge or slurry, the method comprising adding a mineral absorbent to said waste and blending said waste and said absorbent together for a predetermined amount of time until said waste behaves like a solid.

25. The method of claim 3 wherein said mineral absorbent is added to said waste in an amount from about 1.5 to 10 weight percent of said waste.

26. The method of claim 25 wherein said mineral absorbent is vermiculite.

27. The method of claim 25 wherein said mineral is selected from the group consisting of vermiculite, perlite and zeolite and combinations thereof.

28. The method of claim 25 wherein said mineral comprises a blend of vermiculite, perlite and zeolite.

29. The method of claim 28 wherein the ratio of vermiculite to perlite to zeolite is 5:3:2 parts by weight.

30. The method of claim 24 wherein said mineral is added in an amount from 2 to 3 weight percent of said waste.

31. The method of claim 27 wherein said mineral is blended with additives selected from the group consisting of sand, cement, lime, coal dust and granular activated charcoal and combinations thereof.

32. A method of solidifying a fluid acting waste which includes a major solids fraction and a minor fluids fraction, the method comprising blending said waste with a mineral additive that absorbs and/or adsorbs some or all of said fluid fraction, said mineral additive being present in an amount from about 1.5 to 10 weight percent of said waste.

33. A method of drying and solidifying a waste in the form of a sludge or slurry, the method comprising mixing said sludge or slurry with at least one mineral additive adapted to adsorb and/or adsorb some or all of liquid in said sludge or slurry, said mixing continuing until said sludge or slurry and said mineral additive are thoroughly blended whereby said sludge or slurry becomes stackable without sloughing, said mineral additive being added to said sludge or slurry in an amount from about 1.5 to 10 weight percent of said sludge or slurry.
